(19) United States
(12) Patent Application Publication
(10) Pub. No.: US 2014/0195359 A1
(43) Pub. Date: Jul. 10, 2014

(54) System and Method for Computer Automated Payment of Hard Copy Bills

(71) Applicant: Andrew William Schulz, Odenton, MD (US)

(72) Inventor: Andrew William Schulz, Odenton, MD (US)

(21) Appl. No.: 13/736,030

(22) Filed: Jan. 7, 2013

(51) Int. Cl. G06Q 20/14

(52) U.S. Cl. CPC G06Q 20/14
USPC 705/16

(57) ABSTRACT

A system and method for paying hard copy bills using a computer is disclosed. Merchants and payors create electronic accounts with this system and method. Merchants generate bills and register them with the merchant account. Payors scan the bill with a computer, cell phone, or other electronic device, and pay the bill with a networked application. Payment method is selected by payor. Third parties can also create accounts and gather data for statistical purposes such as marketing.

### BACKGROUND

### Prior Art

The following is a tabulation of some prior art that presently appears relevant:

### U.S. Patent Application Publications

| Publication Nr. | Kind Code | Publ. Date | Applicant |
|---|---|---|---|
| 20120278232 | A1 | Nov. 1, 2012 | Portal |
| 20110078081 | A1 | Mar. 31, 2011 | Pirzadeh |
| 20070244811 | A1 | Oct. 18, 2007 | Tumminaro |
| 20110238569 | A1 | Sep. 29, 2011 | Kim |
| 20110022515 | A1 | Jan. 27. 2011 | Tallitsch |

### FIELD OF INVENTION

The present invention relates to the field of electronic commerce, more specifically to transactions involving hard copy bills and completed using a computer or mobile device.

### BACKGROUND OF INVENTION

Cell phones and computers are an integral part of modern life. There is a multitude applications on cell phones and computers which exist to make life easier and more convenient. There are applications for everything from navigation and weather reports to automatic stock price monitoring. The thing in common with many applications is that they automate tasks that people need to do in ways that are less tedious and more user friendly than any manual equivalent.

One common function of life that has not yet found use of such applications is paying paper bills. Although there are various on-line bill paying technologies already in existence, there remain circumstances that demand use of paper bills, such as restaurant bills. Although one aim of the present invention is to bypass “standing in line” to pay a bill via such an application, the full scope of the invention is for payment of any paper bill electronically.

### SUMMARY OF INVENTION

In accordance with this invention, bills may be paid by cell phone or computer by taking a photograph of the bill and using an application to transact the payment using a networked server or system of servers.

### BRIEF DESCRIPTION OF THE DRAWINGS

FIG. 1—This figure is a flowchart depicting the steps in making electronic payment using this invention

FIG. 2—This figure depicts the discrete parts of a typical system implementing this invention and the corresponding network connection.

FIG. 3—This figure is a flowchart depicting multiple persons paying for parts of the same bill.

### DETAILED DESCRIPTION

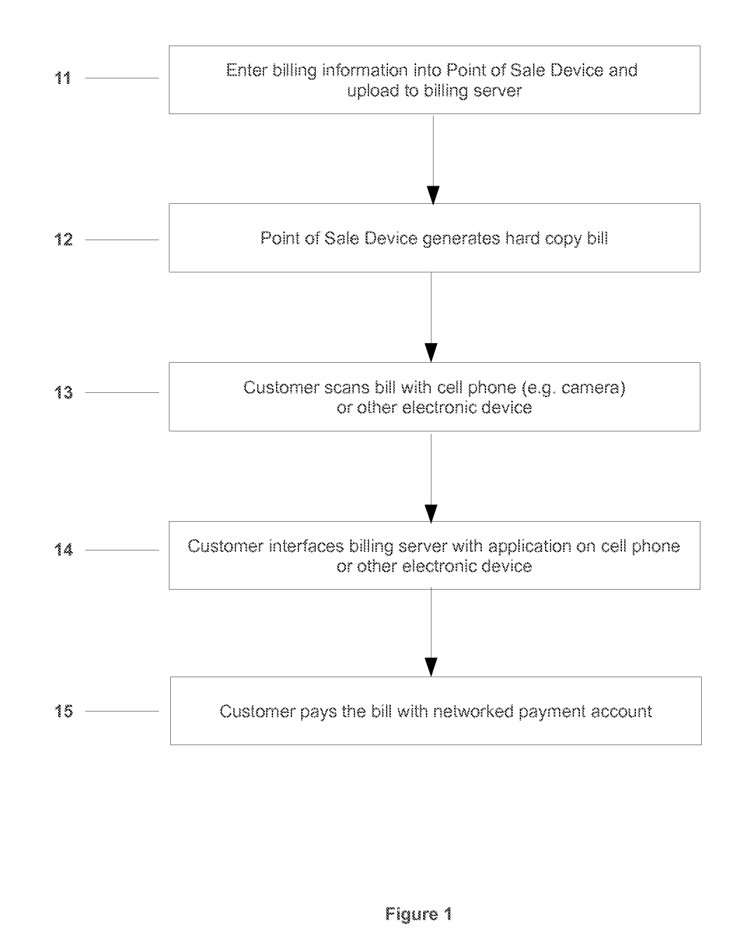

This invention is a system and method for making payments of paper or other physical bills electronically using a computer. This computer can be the traditional desktop or laptop but also includes mobile devices such as but not limited to PDAs, cell phones, and tablet computers. The computer must contain both a network connection and a visual input device such as a camera, barcode scanner, or any other visual input device as well known in the art. FIG. 1 depicts a typical sequence of events using the methodology in accordance with this invention. The method starts with a merchant using the uploading step 11 to get the billing information to a network connected server that handles the transaction. Next is the generating step 12 whereby a visual representation of a bill such as but not limited to a paper hard copy of the bill is created. The visual representation of the bill contains at least some computer recognizable format as is well known in the art (e.g. barcode, QR code, plain text etc.). This visual representation is scanned by the payor in the scanning step 13 with the visual input device on the payor's computer, and an electronic representation of the paper bill is generated by an application on the computer for upload to the same server in the payor upload step 14. Once uploaded to the server, the data scanned from the visual representation of the bill uniquely identifies the bill. Finally, in the payment step 15 the payor uses the application to make payment to the server using any electronic payment system accepted by the server, such as but not limited to credit card, debit card, electronic wire transfer, prepaid account, etc.

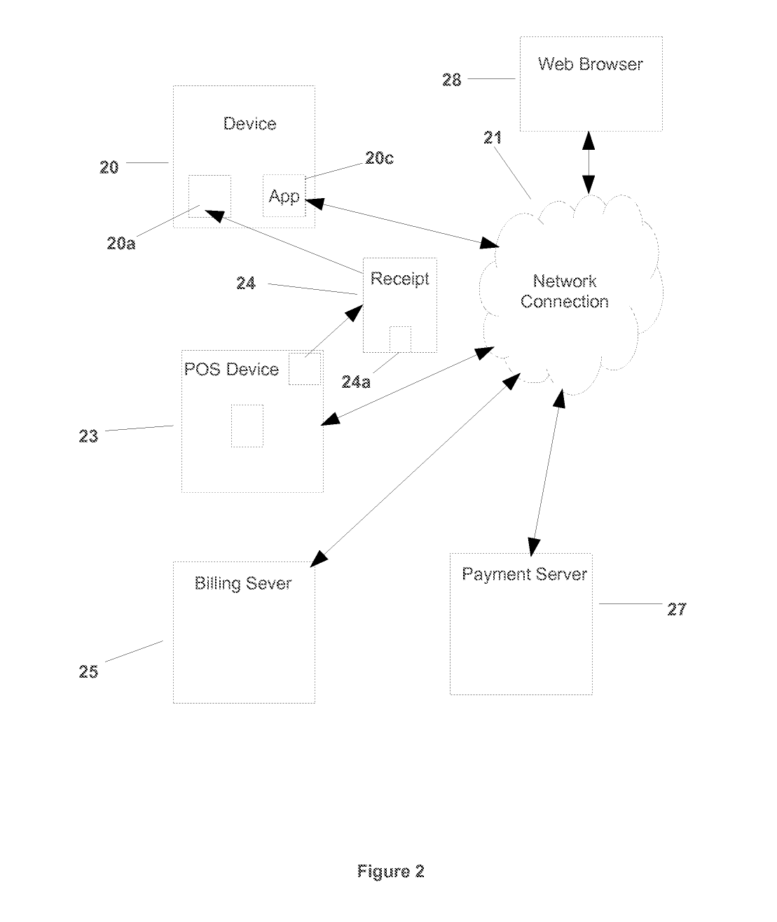

FIG. 2 depicts the relationships between parts of a representative system in accordance with this invention. The point of sale device (“POS”) 23 (which includes an integrated or external printing devices capable of printing the bill) interfaces the billing server 25 through a network connection 21 and generates a bill (or receipt or invoice) 24 that contains the visual representation of the bill 24a from the billing information from the server 25. The billing server 25 also interfaces the application 20c on the payor's device 20, and the payment server 27 via a network connection 21 to facilitate the exchange of payment between the payor and merchant. The billing server 25 verifies payor and merchant credentials to secure all communications with the payment server 27 and handles payment information for the payor and merchant to allow the payment server 27 to exchange payment between the two parties.

Use of the system starts with the merchant entering billing information into the POS 23 which then uploads the billing information to the billing server 25 to register the transaction. Then the billing server 25 responds with the information needed to generate the visual representation of the bill 24a. The POS 23 prints the bill 24 with the visual representation of the bill 24a after receiving the necessary data from the billing server 25. The POS device 23 is notified that the transaction has been paid for (see following paragraph) and closed when the billing server 25 receives confirmation from the payment server or servers 27 that full payment is processed and received.

The visual representation of the bill 24a is presented to the payor and then the payor scans the bill with input device 20a and uses the application 20c on the payor's computer 20 to pay the bill 24. The application 20c uses following steps to complete the transaction: (1) verify/authenticate logon credentials, (2) input the visual representation of the bill 24a, (3) process the visual representation of bill 24a, (4) interface the billing server 25 to retrieve billing information, (5) select payment method or methods, (6) make authorized payment or payments from payment server(s) 27, and (7) verify payment completion from the billing server 25. These steps need not be performed in this exact order, however, the verify/authenticate step must come before payment is processed and the visual representation 24a must be scanned before interfacing the billing server 25. In other words, the input of the visual representation may either precede or follow the authentication step in a particular embodiment of this invention.

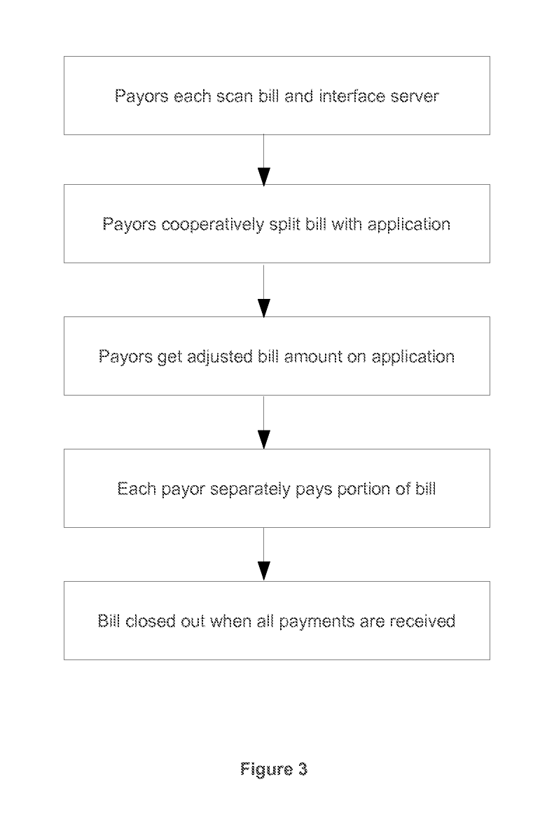

Optionally, any number of payors can claim ownership of part of the bill 24 and participate with the payment by separately scanning the visual representation of the bill 24a with their own respective applications 20c. See FIG. 3. The billing server 25 sends the billing information to each payor. The application 20c may also provide a mechanism for the payor to pay for part or all of individual items on the bill 24 or pay for a numerical (fractional) proportion of the bill 24. In the most efficient embodiment (i.e. most cost effective as of the time of the conception of this invention), after all the items of the bill 24 are claimed by payors, the payment information from each payor is collected by the billing server 25 and processed via the payment server 27 or servers. However, there is no reason all items on the bill 24 must be claimed before processing payment, i.e. individual payments may be processed as each payor uses the application 20c.

Although FIG. 2 depicts the POS 23, billing server 25, application 20c, and payment server 27 as distinct and discrete entities, there is no reason why they must reside on physically separate machines. For example, the POS 23 and billing server 25 could reside on the same physical machine owned by the merchant or the billing 25 and payment servers 27 might all reside somewhere in a computing cloud. Furthermore, there is no requirement that the network connection 21 is the Internet, or even a local network, as it could easily be (at least in part) an internal network inside of a computer (i.e. local loopback). The scope of the system portion of this invention is not limited by the location of the discrete parts of the system, but only that they must logically exist somewhere in some form in order to implement the method portion of this invention.

As stated above, in one class of embodiments multiple payors can claim and pay for parts of a bill 24 using the application 20c on their respective devices 20 to allow for a simple check splitting interface. The check splitting method could be as simple as allowing arbitrary amounts of contributions from each payor, or it could compute contributions from itemized lines on the bill 24. In those cases the billing server 25 coordinates the multiple transactions between the payors, merchant, and payment server or servers 27 to ensure the bill 24 is paid in full and all payors involved transact payment with the merchant.

In order to transact any payment exchange, both payor and merchant must set up accounts used by the billing server 25. Configuration of the payor, merchant, and third party (i.e. advertisers) accounts can be managed through the application 20c or through a web interface 28. Payors can manage their login credentials and their payment methods, review prior transactions, retrieve data based on transaction history, and manage privacy settings (e.g. disallow third party use of information). Merchants can manage their login credentials and their account information, review prior transactions, and produce transaction statistics. Third party users can manage their login credentials and their payment methods, and view data and statistics about payors and merchants based on defined criteria. Data, statistics, and trends can be produced by the billing server 25 (such as popularity of certain menu items at merchant's restaurant) for the merchant and payment and eating trends for the user on their application 20c or website 28.

These account management features for payors, merchants, and third parties are merely examples and are not intended to limit the scope of this invention. Additional features can include anything that makes sense in a given context. For example, a payor account can be able to interface a calorie counter or nutrition analysis application for purchases at a restaurant, or a merchant account can be used to deliver advertisements or coupons to customer accounts.

Although accounts must be set up by at least the merchant and the payor, and the accounts are used by the billing server 25, there is no reason that the accounts must be managed by and exclusively reside on the billing server 25. It is permissible under this invention that these accounts (as well as any 3rd party accounts) may be managed by a completely separate server or servers. In fact, the billing server 25 may conceptually be thought of as the collection of all the discrete but cooperative computing entities that manage both accounts and billing.

We claim:

1. A system for paying hard copy bills electronically comprising a networked bill payment service to facilitate bill creation and payment, a point of sale device that interfaces said bill payment service to create said bill, at least one electronic device with a scanner capable of scanning said bill, an application for paying bills on each said electronic device interfaced to said bill payment service, and at least one networked payment account interfaced to said application and said bill payment server.

2. A system for paying hard copy bills electronically as in claim 1 wherein said bill payment service maintains at least one merchant account that is interfaced with said point of sale device and at least one payor account that is interfaced with said application.

3. A system for paying hard copy bills electronically as in claim 2 further comprising web browser access to said bill payment service.

4. A system for paying hard copy bills electronically as in claim 2 further comprising at least a single third party account maintained by said bill payment server.

5. A system for paying hard copy bills electronically as in claim 4 further comprising web browser access to said bill payment service.

6. A method for paying hard copy bills comprising the steps of creating merchant and payor accounts on a bill payment service, generating a hard copy bill and an electronic representation of said bill on said bill payment service with a point of service device by interfacing said merchant account, scanning the hard copy bill with an electronic device, interfacing said bill payment server via said payor account with an application on said electronic device, validating said payor account login credentials, retrieving said electronic representation of the bill from said billing server with said application on said electronic device via said payor account, selecting payment method registered on said payor account with said application, and finalizing the transaction on both said merchant account and said payor account.

7. A method for paying hard copy bills as in claim 6 further comprising a step of splitting said bill with said application among a multitude of said payor accounts interfaced using a multitude of said electronic devices.

8. A method for paying hard copy bills as in claim 7 further comprising a step of gathering statistical data from transactions involving said merchant account or said payor account.

9. A method for paying hard copy bills as in claim 8 further comprising a step of sending data not specifically related to said bill to said payor account from either said merchant account or a third party account on said bill payment server.

10. A method for paying hard copy bills as in claim 7 further comprising a step of sending data not specifically related to said bill to said payor account from either said merchant account or a third party account on said bill payment server.

11. A method for paying hard copy bills as in claim 6 further comprising a step of gathering statistical data from transactions involving said merchant account or said payor account.

12. A method for paying hard copy bills as in claim 6 further comprising a step of sending data not specifically related to said bill to said payor account from either said merchant account or a third party account on said bill payment server.

13. A method for paying hard copy bills as in claim 6 further comprising a step of sending data not specifically related to said bill to said payor account from either said merchant account or a third party account on said bill payment server.
